(19) United States
(12) Patent Application Publication
(10) Pub. No.: US 2017/0036171 A1
(43) Pub. Date: Feb. 9, 2017

(54) Liquid Purification System

(71) Applicants: Massachusetts Institute of Technology, Cambridge, MA (US); KING FAHD UNIVERSITY OF PETROLEUM AND MINERALS, Dhahran (SA)

(72) Inventors: John H. Lienhard, Lexington, MA (US); Ronan Killian McGovern, Cambridge, MA (US); Syed M. Zubair, Dhahran (SA)

(21) Appl. No.: 15/305,534

(22) PCT Filed: Apr. 23, 2015
(86) PCT No.: PCT/US2015/027310

§ 371 Date: Oct. 20, 2016

Related U.S. Application Data
(60) Provisional application No. 61/982,955, filed on Apr. 23, 2014.

(51) Int. Cl. B01D 61/58; B01D 61/48; C02F 1/469; B01D 61/02; C02F 1/42; C02F 1/44

(52) U.S. Cl. CPC B01D 61/58; C02F 1/42; C02F 1/441; C02F 1/442; C02F 1/4693; B01D 61/025; B01D 61/027; B01D 61/48; B01D 2311/2623; B01D 2317/02

(57) ABSTRACT

A liquid purification system includes a filter system having a set of filters with a feed stream, a concentrate stream, and a permeate stream. The feed stream constitutes an input to the liquid purification system. The liquid purification system also includes an electrodialysis system having at least one stack of at least one pair of electrodes, between which is disposed at least one cell pair having an anion exchange membrane and a cation exchange membrane. The electrodialysis system includes a diluate inlet, a diluate outlet and a concentrate outlet. The diluate inlet is fluidly coupled to the concentrate stream and at least a portion of the diluate outlet is fluidly coupled to at least a portion of the permeate stream to produce a purified output stream. A ratio of electrical conductivity of the purified output stream to the feed stream is no less than about 0.55.

### CROSS-REFERENCE TO RELATED APPLICATIONS

This patent application claims the benefit of U.S. Provisional Patent Application No. 61/982,955 filed Apr. 23, 2014, the disclosure of which is incorporated by reference herein in its entirety.

### TECHNICAL FIELD

The present invention relates to liquid purification systems, and more specifically to liquid purification systems using electrodialysis systems in conjunction with other filtration systems.

### BACKGROUND ART

The economic cost of brackish desalination has grown at an estimated annualized rate of 12% over the past 10 years. Brackish desalination involves the treatment of waters of slight (1,000-3,000 ppm total dissolved solids, TDS) to moderate salinity (3,000-10,000 ppm TDS) present in naturally saline inland aquifers or coastal aquifers that have become subject to the intrusion of seawater. The ratio of water recovered to that withdrawn, known as the recovery ratio, RR, is an important consideration from both environmental and cost perspectives. The benefits of a higher recovery ratio include (1) a reduction in the size of the desalination plant intake; (2) a reduction in the volume of brine produced, which requires disposal to the sea, surface waters or confined aquifers below the aquifer from which water is withdrawn; and (3) a reduction in the rate of aquifer recharge required, which might be done continuously with treated waste water or periodically with water sourced from another location during periods of low demand.

### SUMMARY OF THE EMBODIMENTS

In accordance with one embodiment of the present disclosure, a liquid purification system includes a filter system having a set of filters with a feed stream, a concentrate stream, and a permeate stream. The feed stream constitutes an input to the liquid purification system. The liquid purification system also includes an electrodialysis system having at least one stack of at least one pair of electrodes, between which is disposed at least one cell pair having an anion exchange membrane and a cation exchange membrane. The electrodialysis system includes a diluate inlet, a diluate outlet and a concentrate outlet. The diluate inlet is fluidly coupled to the concentrate stream and at least a portion of the diluate outlet is fluidly coupled to at least a portion of the permeate stream to produce a purified output stream. A ratio of electrical conductivity of the purified output stream to the feed stream is no less than about 0.55.

In accordance with another embodiment of the present disclosure, a method of operating a liquid purification system includes providing a filter system having a set of filters with a feed stream, a concentrate stream, and a permeate stream. The feed stream constitutes an input to the liquid purification system. The method further includes providing an electrodialysis system having a diluate inlet, a diluate outlet and a concentrate outlet. The diluate inlet is fluidly coupled to the concentrate stream and at least a portion of the diluate outlet is fluidly coupled to at least a portion of the permeate stream to produce a purified output stream. The method further includes operating the filter system and the electrodialysis system so that a ratio of electrical conductivity of the purified output stream to the feed stream is no less than about 0.55.

In some embodiments, a ratio of electrical conductivity of the concentrate stream to the electrical conductivity of the feed stream is no greater than a factor of 2. The electrodialysis system may further include an ion exchange resin between the anion exchange membrane and the cation exchange membrane. The filter system may be a reverse osmosis system and/or a nanofiltration system. A filter within the set of filters may include a reverse osmosis membrane, a nanofiltration membrane, or both. A filter within the set of filters may have a rejection of sodium chloride of no greater than about 90% using standard brackish water test conditions.

### BRIEF DESCRIPTION OF THE DRAWINGS

The foregoing features of embodiments will be more readily understood by reference to the following detailed description, taken with reference to the accompanying drawings, in which:

FIG. 1 shows a schematic diagram of a liquid purification system according to embodiments of the present invention;

FIG. 2 shows an exemplary schematic diagram of a filter in a filter system according to embodiments of the present invention;

FIG. 3 schematically shows a perspective view of an exemplary set of filters in a filter system according to embodiments of the present invention;

FIG. 4 shows an exemplary schematic diagram of an electrodialysis stack according to embodiments of the present invention;

FIG. 5 shows one portion of the electrodialysis stack of FIG. 4 during operation;

FIG. 6 shows an exemplary schematic diagram of an electrodialysis stack with an ion exchange resin between the membranes according to embodiments of the present invention;

FIG. 7 shows a schematic diagram of a liquid purification system with multiple electrodialysis stacks according to embodiments of the present invention;

FIG. 8 depicts an exemplary multi-stack electrodialysis system used in a liquid purification system according to embodiments of the present invention;

FIG. 9 is a graph of the water cost versus the recovery ratio for a hybrid system; and

FIG. 10 is a graph of the optimal recovery ratio versus the conductivity ratio of purified output to feed.

### DETAILED DESCRIPTION OF SPECIFIC EMBODIMENTS

Various embodiments of the present invention provide a liquid purification system and method of operating same. The liquid purification system is a hybrid system that combines a filter system with an electrodialysis system in order to provide a reduction in water costs relative to stand alone electrodialysis systems and an improvement in recovery ratio relative to some filter systems, such as reverse osmosis systems and/or nanofiltration systems. Embodiments of the liquid purification system reduce the operating costs of the system by shifting salt removal to a higher salinity by modelling the energy and equipment costs of electrodialysis as a function of product salinity. Details of illustrative embodiments are discussed below.

Definitions. As used in this description and the accompanying claims, the following terms shall have the meanings indicated, unless the context otherwise requires:

A “set” includes at least one member.

If a “set of filters” has more than one member, each of the members of the set is fluidly coupled to at least one other member.

A “filter” is a filtration medium defining a retentate side and a permeate side across which a hydraulic pressure gradient is established.

A “filtration medium” is a medium selected from the group consisting of a nanofiltration membrane, a reverse osmosis membrane, and combinations thereof.

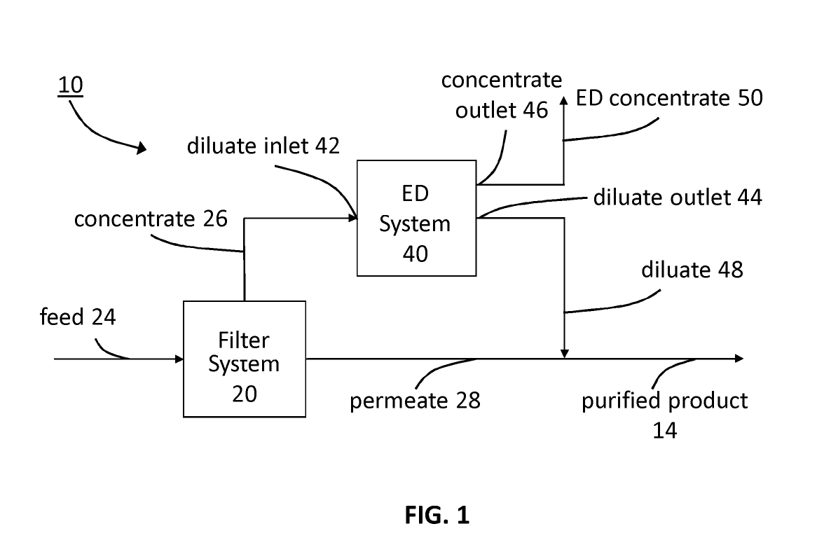

FIG. 1 shows a schematic diagram of a liquid purification system 10. The liquid purification system 10 includes a filter system 20 having one or more filters 22 with a feed stream 24, a concentrate stream 26, and a permeate stream 28. The feed stream 24 constitutes an input to the liquid purification system 10. The filter system 20 is described in more detail below. The liquid purification system 10 also includes an electrodialysis system 40 having a diluate inlet 42 fluidly coupled to the concentrate stream 26, a diluate outlet 44 and a concentrate outlet 46. The electrodialysis system 40 produces a concentrate 50, which flows through the concentrate outlet 46 and the system 40 produces a diluate 48, which flows through the diluate outlet 44. At least a portion of the diluate outlet 44 is fluidly coupled to at least a portion of the permeate stream 28 in order to produce a purified output stream 14 for the liquid purification system 10. The electrodialysis system 40 and variations thereof are described in more detail below.

In certain applications, it is desirable to substantially reduce the salinity of brackish feed water, for example, to reduce the salinity of the feed water by a factor of 5, 10, 30 or even 100. A common approach in these instances is to employ a two-stage reverse osmosis system. First, reverse osmosis rejects salt very well and can achieve a feed to final product salinity ratio of 100 or above. Second, each stage of reverse osmosis typically allows for the recovery of up to 50% of its inlet stream as a permeate. Therefore, a two-stage system can recover 75% of the feed stream as a purified product stream, thus minimizing waste. However, the recovery of more than 75% of the feed water as a purified product requires a three-stage or four-stage reverse osmosis system. As such, this process can become quite expensive. The liquid purification system 10 uses electrodialysis, that allows for high feed water recovery, coupled with filter systems, such as reverse osmosis systems and/or nanofiltration systems, that allow for high final product purity and high overall system recovery.

Another application, which remains unaddressed by current hybrid systems, is the partial desalination of a saline feed stream, for example, a salinity ratio of the feed stream to the final product stream of less than 4, less than 2 or even less than 1.5. One such example is the partial desalination of brackish water from 1,000 ppm total dissolved solids down to 500 ppm total dissolved solids (the World Health Organization drinking water standard). In partial desalination applications, electrodialysis is commonly employed because the size of an electrodialysis system scales roughly with the quantity of salt removed. Therefore, if only partial desalination is required, electrodialysis can be very cost effective.

In partial desalination applications, embodiments of the present invention reduce the overall system cost by introducing a filter system 20, such as reverse osmosis and/or nanofiltration systems, prior to the electrodialysis system 40. This is beneficial because reverse osmosis and nanofiltration systems efficiently block salt passage. Thus, if the filter system permeate 28 is blended with the electrodialysis diluate 48 to form a final product stream 14, it is possible to raise the salinity of the electrodialysis diluate 48 and still achieve the same salinity of the final product stream 14 that was achieved prior to the introduction of the filter system 20. At the same time, the diluate input to the electrodialysis system 40 is increased due to the introduction of the filter system 20. Thus, the overall effect, from the perspective of the electrodialysis system 40, is that the range over which salt is removed is shifted upwards in value. This is beneficial because the cost of removing one unit of salt with electrodialysis increases with the inverse of dilute salinity. Electrodialysis systems are typically operated at just below their limiting current density. Limiting current density is proportional to salinity and membrane area (related to capital cost) per unit salt removed is inversely proportional to current density. Thus, hybridization of an electrodialysis system with a filter system, such as reverse osmosis and/or nanofiltration systems, reduces the capital cost of the electrodialysis system that is required by reducing the size of the electrodialysis system compared to a standalone electrodialysis system that would be used for the same purpose.

When classes of systems and methods that only partially desalinate a feedwater are considered, the design of the reverse osmosis system that is employed in hybrid ED-RO systems is of further interest. For example, typical reverse osmosis systems for brackish feedwaters are two-stage systems. These typically provide a salinity ratio of the concentrate to the feed of roughly 4. However, in electrodialysis systems for partial desalination, the cost of the electrodialysis system per unit of final product water volume flow rate is already low. Furthermore, for a hybrid system to be justified, the cost of the filter system, such as a reverse osmosis or nanofiltration system, that is introduced must be lower than the savings that are enabled in the electrodialysis system. Thus, the filter system is preferably smaller and thus lower in cost in contrast to systems other than those intended for partial desalination. Specifically, in order to reduce the cost of the filter system, it is preferable to reduce the salinity ratio of the concentrate to the feed stream, which decreases the flow rate of permeate per unit flow rate of feed. This in turn decreases the system area required and thus reduces the cost. For example, the salinity ratio of the concentrate to the feed stream could be 3, 2, or 1.5. Finally, it is beneficial to select a membrane, e.g., reverse osmosis or nanofiltration membrane, with a standard sodium chloride salt rejection under brackish conditions of no more than 99%, and preferably 98%, 97%, 95%, or 90% in order to minimize the cost of the filter system unit. In this case, these types of membranes allow for higher permeate flux per unit of hydraulic pressure applied across the membrane and, thus, allow for a smaller membrane area and a smaller system size. Rejection values much lower than 90% are problematic as significant membrane area would then be required to achieve a salinity ratio of concentrate to feed of 3, 2 or 1.5, which is necessary to reduce the electrodialysis system cost.

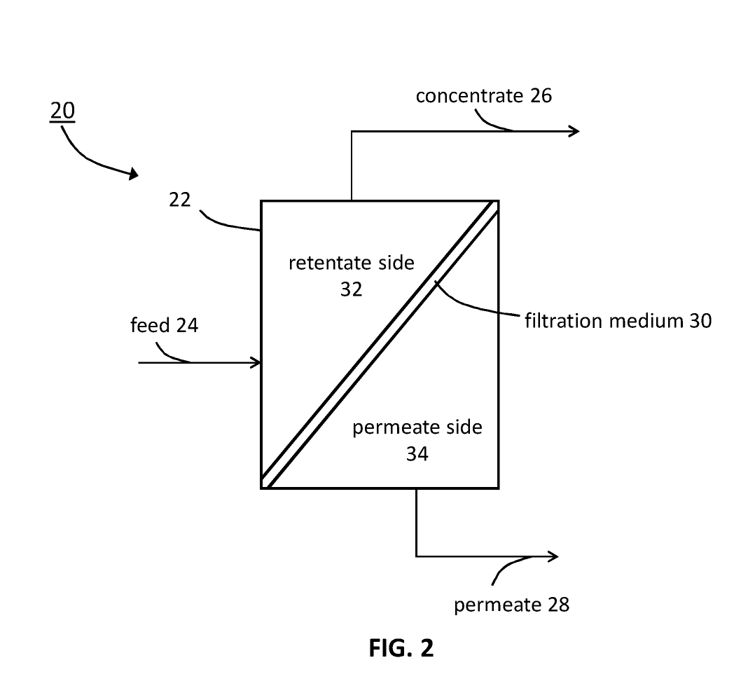

As shown in greater detail in FIG. 2, the filter system 20 includes one or more filters 22 having a filtration medium 30 that defines a retentate side 32 and a permeate side 34 of the filter across which an hydraulic pressure gradient is established. For example, the filter system may be a reverse osmosis system and the filtration medium may be a reverse osmosis membrane. As known by those skilled in the art, reverse osmosis (RO) is a liquid purification process that uses a semipermeable membrane to remove particles and/or solutes from liquids, e.g., drinking water. In reverse osmosis, an applied pressure is used to overcome the osmotic pressure in order to remove various types of molecules and ions from solutions. The solute is retained on the pressurized side of the membrane, or the retentate side 32, and the purified solvent is allowed to pass to the permeate side 34 of the membrane 30. The ability of a reverse osmosis membrane to prevent the passage of solutes is dependent on operational parameters such as influent pressure, solute concentration, and water flux. In some embodiments, the reverse osmosis membrane may have an average pore size of less than about 0.001 μm. In certain embodiments, the reverse osmosis membrane may have a molecular weight cutoff of less than about 200 g/mol.

Alternatively, or in addition, the filter system may be a nanofiltration system and the filtration medium may be a nanofiltration membrane. As known by those skilled in the art, nanofiltration is a filtration system that includes membranes having nanometer sized pores. For example, the nanofiltration membrane may have an average pore size of between about 0.001 μm and about 0.01 μm in some embodiments. In certain embodiments, the nanofiltration membrane may have a molecular weight cutoff of between about 200 g/mol and about 20,000 g/mol. Similar to reverse osmosis, the ability of a nanofiltration membrane to prevent the passage of solutes is dependent on operational parameters such as influent pressure, solute concentration, and water flux.

The rejection percentage of a filtration medium with respect to a salt is generally calculated by dividing the weight percentage of the salt within the permeate stream by the weight percentage of the minor component within the liquid feed stream, and multiplying by 100%, when the filter is operated at steady state. When determining the rejection percentage of a filtration medium with respect to a salt under standard brackish water test conditions, the filtration medium should be arranged as a single spiral wound membrane element that is, e.g., 8 inches in diameter and 40 inches in length. Preferably, the filtration medium should contain 30 mil thick feed channel spacers to produce an active membrane area that is 400 square feet. The permeate flow rate should be equal to 10% of the feed flow rate. In addition, for standard brackish water test conditions, the feed stream should include only the salt whose rejection percentage is being determined and water, with the concentration of the salt being 0.15% by weight. In addition, the feed stream should be set at a temperature of 25 degrees Celsius, have a pH of 7, and be fed to the filter at a pressure of 200 psi gauge.

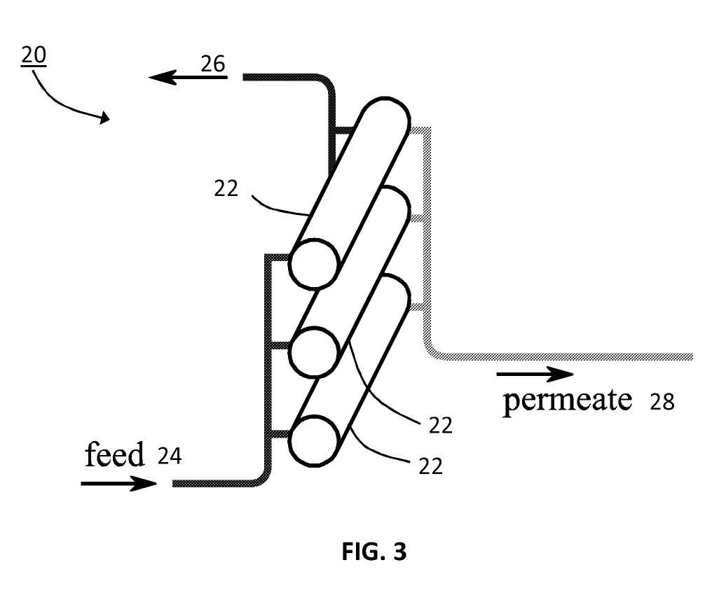

When the filter system 20 includes two or more filters 22, such as shown in FIG. 3, each filter is fluidly coupled to the feed stream 24, the concentrate stream 26 and the permeate stream 28.

In some embodiments, the filter 22 may include a thin film composite membrane. For example, the thin film composite membrane may include a non-woven fabric with a thickness of about 150 μm used as a mechanical support. A porous polysulfone layer (e.g., roughly 60 μm in thickness) may be placed upon the support layer by any known process, such as a phase inversion method. A polyamide layer (e.g., about 200 nm) may be disposed upon the polysulfone layer using any known process, such as interfacial polymerization.

Suitable filters may include those available from Hydranautics (Oceanside, Calif.) (e.g., under part numbers ESPA2-4040, ESPA2-LD-4040, ESPA2-LD, ESPA2MAX, ESPA4MAX, ESPA3, ESPA4-LD, SanROO HS-4, SanRO HS2-8, ESNA1-LF2-LD, ESNA1-LF2-LD-4040, ESNA1-LF-LD, SWC4BMAX, SWC5-LD-4040, SWC5-LD, SWC5MAX, SWC6-4040, SWC6, SWC6MAX, ESNA1-LF2-LD, ESNA1-LF-LD, ESNA1-LF2-LD-4040, ESNA1-LF-LD-4040, HYDRAcap60-LD, and HYDRAcap60); Dow Filmtec via Dow Chemical Company (Midland, Mich.) (e.g., under part numbers HSR0-390-FF, LC HR-4040, LC LE-4040, SW30HRLE-4040, SW30HRLE-440i, SW30HRLE-400i, SW30HRLE-370/34i, SW30XHR-400i, SW30HRLE-400, SW30HR-380, NF90-400, NF270-400, NF90-4040); Toray Industries, Inc. (e.g., under part numbers TM720-440, TM720C-440, TM720L-440); Koch Membrane Systems, Inc. (Wilmington, Mass.) (e.g., under part numbers 8040-HR-400-34, 8040-HR-400-28); and LG NanoH2O (El Segundo, Calif.) (e.g., under part numbers Qfx SW 400 ES, Qfx SW 400 SR, Qfx SW 400 R).

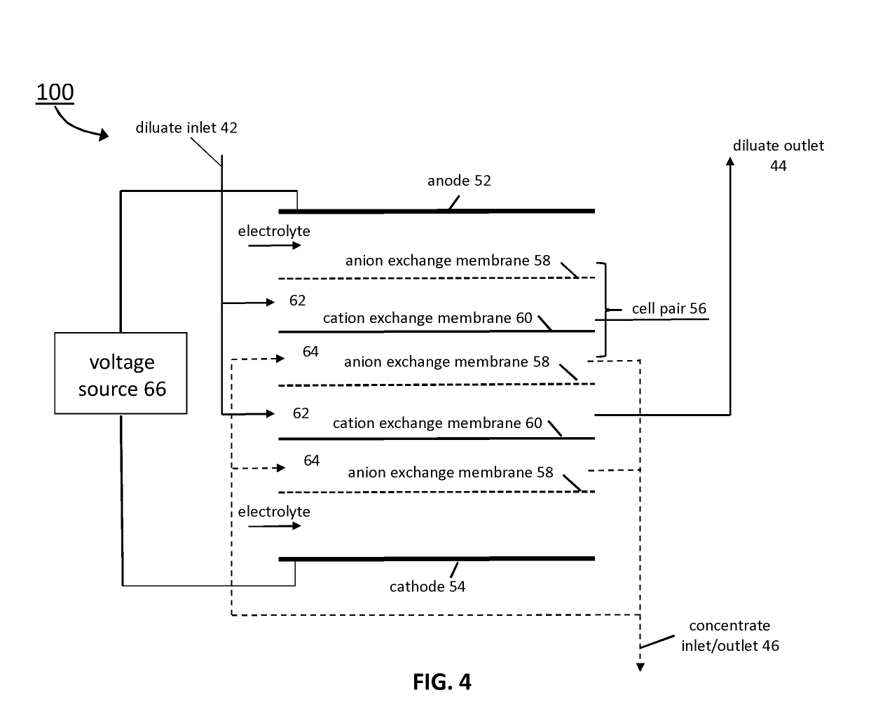

As shown in greater detail in FIG. 4, the electrodialysis system 40 includes at least one electrodialysis stack 100. The stack 100 includes a pair of electrodes, namely, an anode 52 and a cathode 54. The stack 100 also includes at least one cell pair 56 disposed between the electrodes 52, 54. Each cell pair 56 includes an anion exchange membrane 58, which only allows anions to pass through, a cation exchange membrane 60, which only allows cations to pass through, a diluate channel 62 defined by the membranes 58, 60 to allow the diluate 48 to pass through the channel 62, and a concentrate channel 64 defined by the membranes 58, 60 to allow the concentrate 50 to pass through the channel 64. In various embodiments, the ion exchange membranes 58, 60 may be any of the Neosepta CMX, CIMS, CMB, AMX, AHA, ACS, AFN, AFX or ACM membranes, manufactured by Astom Corporation, headquartered in Tokyo, Japan.

As mentioned above, the anion and cation exchange membranes 58, 60 of each cell pair 56 define a channel through which a fluid may flow. When the stack 100 includes multiple cell pairs 56, the cell pairs 56 are arranged so that the anion exchange membranes 58 alternate with the cation exchange membranes 60 in the layers of membranes. In various embodiments, a stack 100 may include various channels, e.g., up to two thousand (2000) channels, defined by the alternating anion and cation exchange membranes 58, 60. In some embodiments, the exchange membranes 58, 60 are separated by a constant distance so that the channels have uniform height. However, the exchange membranes 58, 60 may alternatively be arranged to form channels of different heights.

The stack 100 includes an inlet 42 that receives the diluate 48, and the stack 100 divides the diluate 48 to flow through alternate channels 62 of the cell pairs 56. The stack 100 receives concentrate 50 through an inlet/outlet 46, which the stack 100 divides to flow through the alternating channels 64 that are not occupied by the diluate 48. In this manner, when diluate 48 flows through a channel 62, concentrate 50 flows through the channels 64 immediately above and below the diluate 48, and vice versa. In some embodiments, the channels immediately adjacent to the anode 52 and cathode 54 contain neither diluate 48 nor concentrate 50.

To operate the electrodialysis stack 100, a voltage source 66 applies a voltage to the electrodes 52, 54, and in response, ionic dissolved solids in the diluate 48 flow through the anion and cation exchange membranes 58, 60 into the concentrate 50. As a result, the stack 100 at least partially desalinates the diluate 48 while increasing the salinity of the concentrate 50.

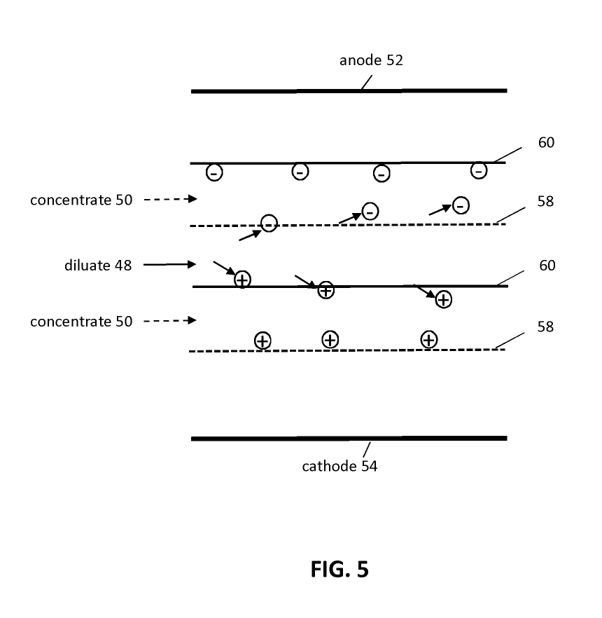

This process is shown in more detail in FIG. 5, which shows an enlarged view of three channels in the stack 100, while various features of the stack 100 have been removed for clarity. During operation, when voltage is applied to the electrodes 52, 54, the anode 52 attracts the anions in the diluate 48 and concentrate 50. For each channel 62 through which diluate 48 flows, the layer closer to the anode 52 is an anion exchange membrane 58. Since anion exchange membranes 58 allow anions to pass through, anions from the diluate 48 permeate the anion exchange membrane 58 to flow into the concentrate 50. However, for each channel 64 through which concentrate 50 flows, the layer closer to the anode 52 is a cation exchange membrane 60. Although anions in the concentrate 50 are attracted to the anode 52, the cation exchange membrane 60 prohibits the anions from permeating the membrane 60. Thus, anions flow from diluate 48 to concentrate 50, and the cation exchange membranes 60 prohibit anions in the concentrate 50 from flowing into the diluate 48.

Similarly, for each channel 62 through which diluate 48 flows, the layer closer to the cathode 54 is a cation exchange membrane 60, and for each channel 64 through which concentrate 50 flows, the layer closer to the cathode 54 is an anion exchange membrane 58. The cathode 54 attracts the cations in the diluate 48 and concentrate 50, but the cation exchange membranes 60 allow cations to flow from the diluate 48 into the concentrate 50 while the anion exchange membranes 58 prohibit cations from leaving the concentrate 50.

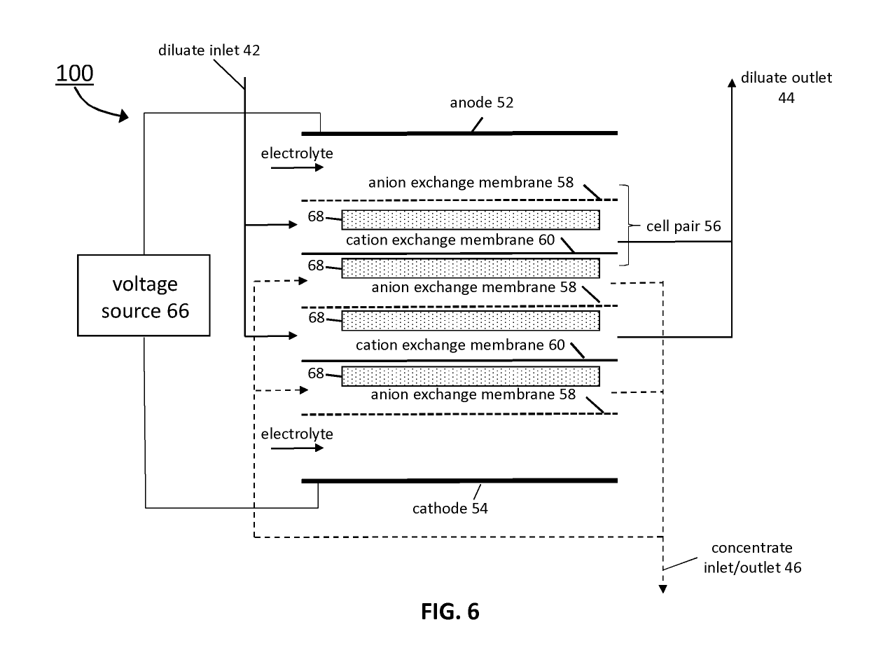

As shown in FIG. 6, the electrodialysis stack 100 may include an ion exchange resin 68 between the anion and cation exchange membranes 58, 60. In this case, the stack 100, with the ion exchange resins 68, functions in a manner similar to already described above with respect to FIGS. 4 and 5. When the electrodialysis system 40 uses one or more stacks 100 having ion exchange resins 68, the system 40 may also be known as an electrodeionization system.

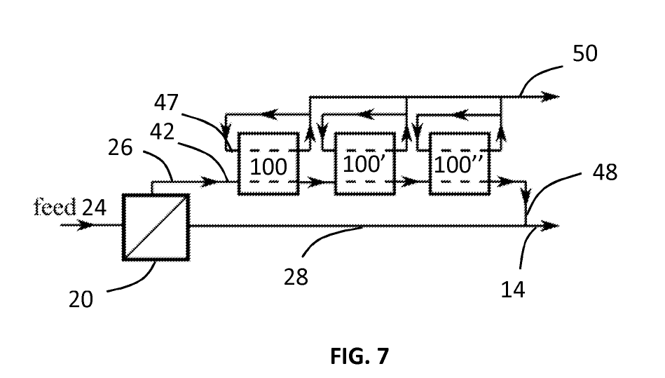

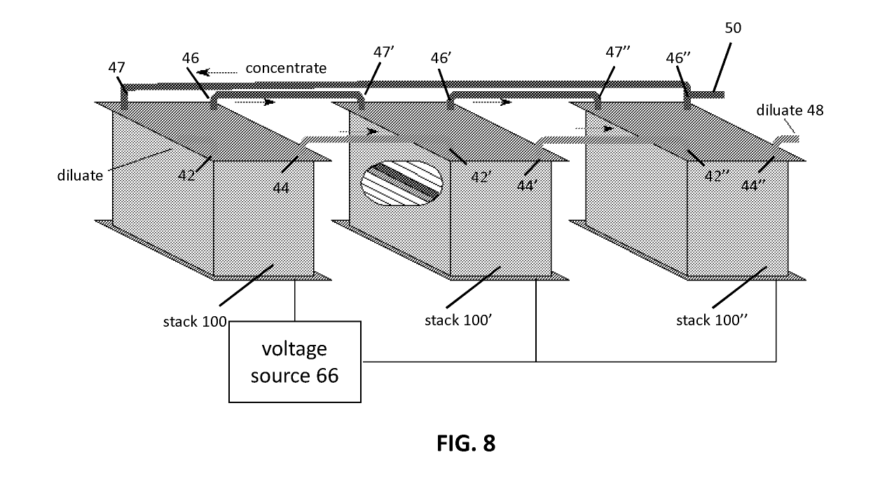

As shown in FIGS. 7 and 8, the electrodialysis system 40 may include multiple stacks 100, 100′, 100″ connected in series. In this case, each stack 100, 100′, 100″ includes elements previously described with respect to stack 100 in FIGS. 4 through 6, namely, a pair of electrodes 52, 54 and at least one cell pair 56 having an anion exchange membrane 58, a cation exchange membrane 60, a diluate channel 62 and a concentrate channel 64. Optionally, one or more stacks 100 may include ion exchange resins 68 between the anion and cation exchange membranes 58, 60. The stacks 100, 100′, 100″ may include an equal numbers of cell pairs 56 in each stack or may have different numbers of layers.

As shown in more detail in FIG. 8, the multi-stack electrodialysis system 40 continuously flows concentrate 50 through alternate channels of the stacks 100, and the system 40 includes concentrate inlets 47 and concentrate outlets 46 that are fluidly coupled to re-circulate the concentrate 50 among the stacks 100. The first stack 100 receives the concentrate 50 through an inlet 47, divides the concentrate 50 to flow through alternate channels 64, aggregates the concentrate 50 into a single stream at the end of the layers, and sends the concentrate 50 stream through an outlet 46 that is fluidly coupled to the inlet 47′ of the next stack 100′. The next stack 100′ processes the concentrate 50 in a similar manner, and the last stack 100″ sends the concentrate 50 through an outlet 46″ that is fluidly coupled to the inlet 47 of the first stack 100. Alternatively, or in addition, the diluate inlet 42 may be connected to the concentrate inlet 47 in order to allow for a bleed stream of fluid from the feed to the concentrate 50.

As for the diluate 48, the first stack 100 receives diluate 48 through the inlet 42 and divides the diluate 48 to flow through the channels 62 not occupied by the concentrate 50. The voltage source 66 applies a voltage to the electrodes 52, 54 of the first stack 100, and the voltage pulls ionic dissolved solids in the diluate 48 across the anion and cation exchange membranes 58, 60 into the concentrate 50, thereby at least partially desalinating the diluate 48. At the end of each layer, the stack 100 aggregates the channels of diluate 48 into a single stream and flows the diluate 48 through an outlet 44. In the multi-stack system 40, each outlet 44 of a stack 100 is fluidly coupled to the inlet 42 of the subsequent stack 100. Thus, each subsequent stack 100 receives diluate 48 that has been further desalinated by the previous stack 100, and the voltage applied to the stack's electrodes 52, 54 pulls additional ionic dissolved solids in the diluate 48 across the exchange membranes 58, 60 into the concentrate 50. The final stack 100 in the system 40 flows the diluate 48 through an outlet 44″ that is fluidly coupled to at least a portion of the permeate stream 28 in order to produce a purified output stream 14 for the liquid purification system 10.

Electrodialysis systems typically operate at voltages of about 0.5-1.5 Volts per cell pair to desalinate diluates 48 with relatively low levels of salinity. In addition, electrodialysis systems are conventionally used to desalinate fluids with conductivity below 0.1 Siemens/m.

Electrodialysis is well suited to applications requiring high recovery ratios for at least three reasons. First, electrodialysis is a salt removal rather than a water removal technology, and so the majority of the feed water is easily recovered as a product. This is in contrast to reverse osmosis, where high recovery ratios require multiple stages in a continuous process or longer process times in a semi-batch (or batch) process. Second, electrodialysis is capable of reaching brine concentrations above 10% total dissolved solids (TDS), which is beyond the osmotic pressures reachable by current reverse osmosis systems. Third, seeded precipitation of sealants in the electrodialysis process can, in some cases, circumvent the barrier on water recovery imposed by the solubility of feedwater solutes.

Although electrodialysis systems enjoy the advantage of high water recovery, costs increase with the amount of salt removal required. This is particularly true at low salinity where salt removal rates, which scale with the electrical current, are limited by the rate of diffusion of ions to the membrane surface. This phenomenon, known as the limiting current density, as well as the high electrical resistance of solutions at low concentrations, increases the costs of electrodialysis at low salinity. Thus, embodiments of the present invention take advantage of the synergy between the electrodialysis systems, providing high recovery, with filter systems, such as reverse osmosis systems and/or nanofiltration systems, providing final high product purity.

For example, in order to understand the benefits of embodiments of the present invention for partial desalination, the cost is considered per unit volume of the purified output stream of the overall system. This total cost may be broken down into the sum of the contribution to cost of the electrodialysis system and of the reverse osmosis system:

Cₜₒₜ=C_{ED}+C_{RO}

where Cₜₒₜ is the total cost in $/m³ of the purified output stream, C_{ED} is the contribution of the electrodialysis system to that total cost (also measured in $/m³ of the purified output stream) and C_{RO} is the contribution of the reverse osmosis system to that total cost (also measured in $/m³ of the purified output stream).

The contribution of the reverse osmosis system to the total cost may be approximated as:

$${C}_{RO} = RR \frac{RR}{{RR}^{0}} {K}_{RO}$$

wherein RR is the recovery ratio of the reverse osmosis system, defined as the volume flow rate ratio of the permeate stream to the feed stream, RR⁰ is the recovery ratio of a reference reverse osmosis system that costs K_{RO} $ per cubic meter of permeate produced (including energy costs, operational costs and amortized equipment (capital) costs). For example, in some embodiments, K_{RO} is between about $0.05/m³ and $0.5/m³, and may be, for example, about $0.2/m³.

The contribution of the electrodialysis system to the total cost may be broken into the contribution from energy C_{ED,E} and capital C_{ED,C}:

C_{ED}=C_{ED,E}+C_{ED,C}.

The contribution to electrodialysis costs of energy may be written as:

$${C}_{ED , E} = ( 1 - RR ) {K}_{E} \frac{1}{3.6 E 6 \frac{J}{kWh}} VF ( \frac{{k}_{c}}{{Λ}_{c}} - \frac{{k}_{d , o}}{{Λ}_{d}} )$$

K_{E} is the cost of electricity, which may be between about $0.05 per kWh and $0.3 per kWh, and may be, for example, about $0.1/kWh.

V is the voltage across each cell pair in each electrodialysis stack and may be between about 0.1 V and 2 V, for example, about 0.6 V.

k_{c} is the electrical conductivity of the concentrate stream of the reverse osmosis system (or the diluate inlet of the electrodialysis system) in Siemens per meter and k_{d,o} is the electrical conductivity of the diluate outlet of the electrodialysis system in Siemens per meter.

F is Faraday's constant and equals about 100,000 Coulombs per mol.

Λ_{c} is the molar conductivity of the concentrate stream (or the diluate inlet) in Siemens times square meters per mol and Λ_{d,o} is the electrical conductivity of the diluate outlet also in Siemens times square meters per mol.

The contribution to electrodialysis costs of equipment may be written as:

$${C}_{ED , C} = ( 1 - RR ) {K}_{C} \frac{1}{\frac{1}{r} ( 1 - {( \frac{1}{1 + r} )}^{T} )} \frac{1}{3.15569 e 7 \frac{s}{yr}} \frac{F}{\frac{DShF}{4 {h}_{d} MWs}} ln ( \frac{\frac{{k}_{c}}{{Λ}_{c}}}{\frac{{k}_{d , o}}{{Λ}_{d}}} )$$

The above formula assumes that the current density in the stack is roughly equal to the limiting current density (strictly speaking it must be lower). K_{C} is the capital cost of a multi-stack electrodialysis system, divided by half of the total areas of the anion and cation exchange membranes in the stack. In some embodiments, the surface area may be expressed in m². In some embodiments, K_{C} may be between about 25 and about 150 $/m², and in one embodiment, K_{C} is about 50 $/m².

r is the annual cost of capital, expressed as an interest rate. In some embodiments, the interest rate may be between about 5-15%, and may be, for example, about 5%.

T is the equipment life in years. In some embodiments, T may be between about 10 years and about 20 years, and may be, for example, about 20 years.

D is the number averaged diffusivity of salts in the diluate in the electrodialysis system, for example 1.61e-9 square meters per second.

Sh is the dimensionless spatially averaged Sherwood number in the diluate channels of the ED system, for example 20.

MWₛ is the mass averaged molar mass of salts in the diluate in the electrodialysis system in grams per mol, for example 58.66 grams per mol for sodium chloride.

h_{d} is the height of a diluate channel. This height may be the distance between the anion and cation exchange membranes between which a diluate flows, and the height may be expressed in meters. In various embodiments, the height may be between about 0.3 and about 2.5 mm (e.g., between about 0.3×10⁻³ m and 2.50×10⁻³ m), and may be, for example, about 0.0005 m.

The relationship between the recovery ratio of the reverse osmosis system RR, the feed stream conductivity k_{f} and the concentrate stream conductivity k_{c} is roughly given by:

$${k}_{c} = \frac{1}{1 - RR} {k}_{f}$$

The above relationship assumes that the majority of dissolved ionic solids in the feed stream are retained within the concentrate stream. The relationship describing the purified output conductivity kₚ of the entire system is approximately given by:

kₚ=(1−RR)k_{d,o}+k_{f}SP RR

SP is the salt passage, which may be defined as the conductivity ratio of the permeate to the feed stream and may be between about 0.5 and 0.998, and may be, for example, about 0.992.

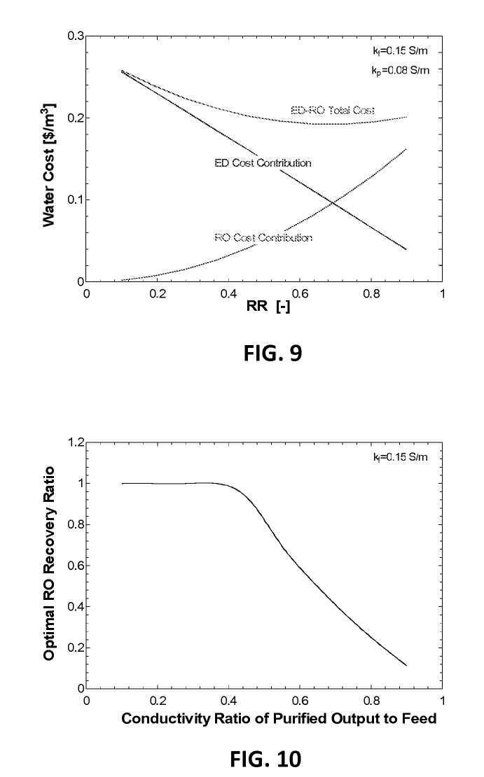

FIG. 9 shows how the cost of water from an ED-RO hybrid system depends upon the recovery ratio of the reverse osmosis system for a feed stream conductivity of 0.15 S/m and a purified output stream of 0.08 S/m. The limit where the recovery ratio tends to zero corresponds to an electrodialysis system with no reverse osmosis system. Clearly, the total cost of water is minimized when the recovery ratio is above zero (in fact, about 70% in this scenario)—meaning that it is economically beneficial to include a reverse osmosis system. This illustrates the utility of the present liquid purification system for partial desalination relative to the conventional approach of employing only an electrodialysis system.

FIG. 10 illustrates the benefits of the present liquid purification system approach specifically for partial desalination applications. Here, the feed conductivity is held constant at 0.15 S/m, the conductivity ratio of the purified output to the feed is varied (equivalent to varying the conductivity of the purified output since the feed conductivity is held constant for this figure), and, for each value of the conductivity ratio of the purified output to the feed, the above equations are solved to find the value of the recovery ratio that minimizes the cost of water Cₜₒₜ (i.e., the minimum on FIG. 9). When the optimal recovery ratio reaches unity (e.g., all of the product water is produced by the reverse osmosis system and none by the electrodialysis system), this suggests that the best system is a pure reverse osmosis system. When the optimal recovery ratio is less than unity (but greater than zero) this suggests that a liquid purification system of the present invention is most cost effective. Importantly, FIG. 10 shows that for significant levels of salt removal (i.e., when the conductivity ratio of product output to feed is below about 0.5) it is most economic to operate with a reverse osmosis system and not a hybrid system (despite the suggestions in the literature of using a hybrid system for such applications). However, for partial desalination (i.e., when the conductivity ratio of product output to feed is above roughly 0.5) it is most economic to adopt a liquid purification system of the present invention.

Although the above discussion discloses various exemplary embodiments of the invention, it should be apparent that those skilled in the art may make various modifications that will achieve some of the advantages of the invention without departing from the true scope of the invention.

1. A liquid purification system comprising:
a filter system having a set of filters with a feed stream, a concentrate stream, and a permeate stream, wherein the feed stream constitutes an input to the liquid purification system; and
an electrodialysis system having at least one stack of at least one pair of electrodes, between which is disposed at least one cell pair having an anion exchange membrane and a cation exchange membrane, the electrodialysis system having a diluate inlet, a diluate outlet and a concentrate outlet, wherein the diluate inlet is fluidly coupled to the concentrate stream and at least a portion of the diluate outlet is fluidly coupled to at least a portion of the permeate stream to produce a purified output stream,
wherein a ratio of electrical conductivity of the purified output stream to the feed stream is no less than about 0.55.

2. The liquid purification system according to claim 1, wherein a ratio of electrical conductivity of the concentrate stream to the electrical conductivity of the feed stream is no greater than a factor of 2.

3. The liquid purification system according to claim 1, wherein the electrodialysis system further includes an ion exchange resin between the anion exchange membrane and the cation exchange membrane.

4. The liquid purification system according to claim 1, wherein the filter system is a reverse osmosis system.

5. The liquid purification system according to claim 1, wherein the filter system is a nanofiltration system.

6. The liquid purification system according to claim 1, wherein a filter within the set of filters includes a reverse osmosis membrane.

7. The liquid purification system according to claim 1, wherein a filter within the set of filters includes a nanofiltration membrane.

8. The liquid purification system according to claim 1, wherein a filter within the set of filters has a rejection of sodium chloride of no greater than about 90% using standard brackish water test conditions.

9. A method of operating a liquid purification system, the method comprising:
providing a filter system having a set of filters with a feed stream, a concentrate stream, and a permeate stream, wherein the feed stream constitutes an input to the liquid purification system;
providing an electrodialysis system having a diluate inlet, a diluate outlet and a concentrate outlet, wherein the diluate inlet is fluidly coupled to the concentrate stream and at least a portion of the diluate outlet is fluidly coupled to at least a portion of the permeate stream to produce a purified output stream; and
operating the filter system and the electrodialysis system so that a ratio of electrical conductivity of the purified output stream to the feed stream is no less than about 0.55.

10. The method of claim 9, wherein the electrodialysis system includes at least one stack of at least one pair of electrodes, between which is disposed at least one cell pair having an anion exchange membrane and a cation exchange membrane.

11. The method of claim 10, wherein the electrodialysis system further includes an ion exchange resin between the anion exchange membrane and the cation exchange membrane.

12. The method of claim 9, wherein the filter system is a reverse osmosis system.

13. The method of claim 9, wherein the filter system is a nanofiltration system.

14. The method of claim 9, further comprising operating the filter system so that a ratio of electrical conductivity of the concentrate stream to the electrical conductivity of the feed stream is no greater than a factor of 2.

15. The liquid purification system according to claim 2, wherein the electrodialysis system further includes an ion exchange resin between the anion exchange membrane and the cation exchange membrane.

16. The liquid purification system according to claim 2, wherein the filter system is a reverse osmosis system.

17. The liquid purification system according to claim 2, wherein the filter system is a nanofiltration system.

18. The liquid purification system according to claim 2, wherein a filter within the set of filters includes a reverse osmosis membrane.

19. The liquid purification system according to claim 2, wherein a filter within the set of filters includes a nanofiltration membrane.

20. The liquid purification system according to claim 2, wherein a filter within the set of filters has a rejection of sodium chloride of no greater than about 90% using standard brackish water test conditions.
